(19) United States
(12) Patent Application Publication
(10) Pub. No.: US 2011/0302210 A1
(43) Pub. Date: Dec. 8, 2011

(54) System and methods for keeping information and data for proving authorship and priority of ideas, creations, inventions, explanations, declarations, factual assertions and others; for keeping personal documents securely and confidentially; for securing evidence for legal proceedings; and for delivering messages and documents to parties.

(76) Inventor: Gelu Comanescu, Washington, DC (US)

(21) Appl. No.: 13/115,150

(22) Filed: May 25, 2011

Related U.S. Application Data
(60) Provisional application No. 61/348,340, filed on May 26, 2010.

(51) Int. Cl. G06F 17/30

(52) U.S. Cl. 707/784; 707/E17.005

(57) ABSTRACT

We propose a system and a method for providing a confidential secure information, data, evidence and documents holding docket system service where various parties can store information by means such as uploading documents and data files on a computer server. The administrator of the service is legally and contractually bound to securely and confidentially hold the stored documents in trust for the customers and to truthfully certify, at the customer request, that a certain document or file has been created by the said customer on a certain date. Upon contractual agreement between the service provider and the customer the service provider takes on the contractual duty to deliver messages and documents to the customer and to third parties at various times and contingent upon various events according to customer's specifications. Upon contractual agreement the service provider takes on the contractual duty to deliver documents, files and messages anonymously. The administrator also offers to customers the option to publish (e.g. on a website) the documents, the files, the certifications stored on the docket and other information that customer chooses.

### CROSS-REFERENCES TO RELATED APPLICATIONS

Under 35 U.S.C. §119(e), this application claims the benefit of priority of U.S. Provisional Patent Applications filed by inventor Gelu Comanescu as follows: No. 61348340 filed on May 26, 2010 (EFS ID 7689939, confirmation number 4804). The contents of the provisional application are incorporated by reference in their entirety.

### FIELD OF THE INVENTION

The present invention relates to providing services to people via computer and internet systems.

### BACKGROUND OF INVENTION

The last 30 years have seen the development of means to store information on various data storage media (hard disks, solid-state memory; compact disks etc.) and the development of ways people can store information on such storage media remotely via on-line internet services from their homes on storage-media far away from their residence. The current invention is based on digital storage technology and remote access to such data and consist in methods to solve various problems such as: finding the person who first proposed a certain scientific explanation to a phenomenon; finding the person who first proposed a solution to an international crisis; finding the actual first inventor of a certain device; keeping personal documents safely and securely; keeping and securing evidence for legal proceedings; performing trustee service by delivering messages and documents to various parties. In the following we describe the problems solved by the current invention and the circumstances in which these problems arise.

(1). The problem of proving authorship and priority of ideas, creations, and innovations.

We first describe a situation and a problem that often appears in academic and scientific environment. Often in academic and scientific environment there are people that have a scientific idea but are afraid to disclose it because others may misappropriate it. For the sake of clarity we consider a hypothetical person, John Smith, who works as a post-doctoral junior scientist together with other scientists for a research group. The junior scientist has just discovered an explanation to a problem important for society (e.g. why bees in North America are dying; or what the mechanism of cancer cell multiplication is). John cannot go on and just publish an article because that would upset his manager and his colleagues or he may breach a non-disclosure agreement with his employer. The only way to make use of his ideas is to describe these ideas to his colleagues. But if he discloses these ideas to his colleagues he runs numerous risks. First, he runs the risk that one of his colleagues (e.g. a more senior person) will tell him “I was thinking about this before”—it happens very often especially in research groups where people worked on the same project for many years. Second, he runs the risk that his colleagues will not realize right away that the idea is good (or doubt that it will work) and ignore him; then one year later that very same idea “reappears” from someone else and is accepted as coming from another person (these things happen unconsciously). Third, even if his colleagues realize that the idea is valuable, it may happen that he does not have time to publish the idea right away (writing papers takes time) and meantime people talk about that idea with others at conferences and someone else gets the idea, publishes it and claims authorship over the idea.

There are many other work environments where people that have an idea are afraid to disclose it because others may (knowingly or not) misappropriate it. Consider a young lawyer working for a health policy institution (e.g. non-profit, Government, association). Assume the junior lawyer has an idea consisting of a solution to a problem important for society (e.g. how to control healthcare cost, how to best achieve medical tort reform). He cannot have the initiative to publish a paper by himself because that would upset his colleagues and boss. Also, such publication without approval could breach a non-disclosure agreement with his employer. The only way to make use of his idea and innovative solution is to disclose them to his colleagues. But if he discloses his ideas to his colleagues he runs the same risks as the ones described above with respect to John's situation.

All of the above risks cause scientists and other innovators to be quite secretive about their new ideas and innovative solutions, and delay disclosing them to the public. Consequently, society loses because society's interest is that creators, inventors and innovators make their ideas, inventions and creations public as soon as possible so that others can use them. Especially in areas and institutions where articles are not published (e.g. employees of the government, non-profit institutions, senate staffers) there is very little credit given to the actual innovator. Usually the credit goes to the organization and its management. The methods and system in the current invention provide creators, inventors and innovators with a way to prove they are the actual creators, inventors and innovators.

Another problem that often appears in academic and scientific environment is the problem of determining who is a co-author of an invention, innovation, or creation and what are the contributions brought by individual co-authors to said invention, creation or innovation. Often in the research and creation process there is more than one person that contributes to an invention and, as a result, more than one person claim they have contributed to an invention, innovation or creation. Consequently, the issue arises of determining what is the contribution that each claimant had to said invention, creation or innovation; and whether a claimant is entitled to be named as co-author of said invention, innovation or creation.

Sometime creators and innovators want not only to secure authorship and priority over their ideas and creations but also to put the public on-notice that they already had that idea. The current invention also offers a solution to this problem.

(2). The problem of proving priority of inventions in countries employing a first-to-invent patent system.

United States of America adopts a first-to-invent system with respect to determining the party who is the first inventor, whereas most other countries in the world adopt a first-to-file system. In the United States inventors are allowed to bring evidence to prove that they have made the claimed invention up to one year before they have filed for invention patent. While the first-to-invent patent system has many advantages it also has the shortcomings that the evidence inventors bring in support of claims of “invention conception” and “diligence” (as referred in 35 U.S.C. §102) is unreliable. For instance, often inventors support their claim of “date of conception” with evidence such as text written in personal or laboratory notes which do not have a clear date and on which the inventor could have placed a false date. Another type of evidence that inventors bring in support of claims of conception, conception date, and diligence is the witness testimony of colleagues. Often such witnesses are friends and colleagues of the inventor and their testimony refers to discussions which took place many years prior to their testimony. The legal uncertainties with respect to the date evidence was created, reliability of witness testimony and meaning of evidence makes the first-to-invent patent system unreliable, prone to fraud, resource intensive and especially unfriendly to independent and small entity inventors. The present invention offers a method and apparatus that significantly reduces the above shortcomings of the first-to-invent patent system.

(3). The problem of keeping digital documents safely and securely.

Often people keep valuable documents in their house and lose them either by accident (e.g. fire, flooding) or misplace them. Often people make digital copies of their documents and store them on their laptop, then they lose the laptop and all these documents get lost. Examples of such documents are: birth certificate; house mortgage; health documents; social security; retirement plan; contractual agreements; property titles; family information; police records; emails; letters; declarations; immigration documents; education documents; bank information; wills; estate documents and others. People need a method and system to help them store their documents securely and easily access said documents when needed.

(4). The need of tools and methods for securing evidence for use in law enforcement and in legal proceedings.

Many people happen to witness criminal acts, acts indicative of criminal behavior, or acts indicative of future criminal acts. For one reason or another, people who witnessed such acts do not always report them to police right away. Also, many people receive threatening emails, voice-messages, and phone calls which are not criminal at the moment they happen but are indicative of future criminal acts. In such situations it often happens that, months or years later, the person who has witnessed the criminal acts or who received the threats would like to present these facts to law enforcement or as evidence in legal proceedings. Their credibility is diminished by the fact that they present facts that they witnessed long time ago and they described these facts according to their memory. It is well known that people tend to forget more and more details as time goes by. Accordingly, would be good that people who receive threats, or witness criminal acts, or witness acts that precede criminal acts have a way to secure evidence such as descriptions of these acts right at the time these acts happen. The invented method and system helps people to secure such evidence as well as other forms of evidence such as: emails, videos, photos, voice-messages, and voice-recordings right at the time such evidence was produced.

(5). The need of tools and methods for deterring criminals from killing the people who are aware of criminal acts.

Criminals and criminal organizations use violence, murder, and the threat of violence as means for running their enterprise. One of the primary reasons criminal organizations kill their members, associates, and others, is to eliminate potential informants and witnesses. Any person aware of the criminal organization's activities is a potential threat to the organization since they are potential informants and potential witnesses. The working of this strategy employed by criminals has been appropriately captured in the popular culture by the phrase: “Dead people do not tell tales.” Accordingly, killing and the threat to kill are tools of business critical to running a criminal organization. This invention provides a method and system that law enforcement can employ to impair these tools of business used by criminals.

(6). The problem of making documents and messages available to the desired persons and at the desired time.

For the sake of clarity we describe this problem with respect to a fictional person we call Mary. Mary has a severe heart disease and is afraid she may die soon. She is a single mother of a 5 years old son: William. Mary knows that there are a couple of very important facts that William needs to know but he is too young right now. Mary would like William to be informed on his 21^{st} birthday about the following: first that William's actual father is not John, as William knows, but Andrew; second, that William is predisposed to a certain genetic disease which runs in Mary's family; and third Mary wants William to receive the shareholder certificates of a business she inherited from her father. This invention provides a method and system that Mary can use to ensure that on his 21^{st} birthday William receives all the information she wants him to receive, regardless of whether Mary is dead or alive at that time and without Mary confiding to any physical person.

### SUMMARY OF INVENTION

The invented system and methods provide a solution to the problems described above. The invented system consist essentially of an internet based evidence holding docket where people can store data, documents, information, evidence etc. The party practicing the inventions offers the internet based evidence holding docket as a service to people. Hereinafter said people are also referred as “the customers”, said system is also referred as “the docket system,” and said party practicing the invention is also referred as the “service provider.” The customers may store said documents on the docket system by various means such as uploading documents (in the form of digital files) on a website maintained by the service provider. The administrator of the service is legally and contractually bound to securely and confidentially keep the stored documents in trust for the customers and to truthfully certify, at the customer request, that a certain document or file has been created by the said customer on a certain date. Upon contractual agreement between the service provider and the customer the service provider takes on the contractual duty to deliver messages and documents to the customer and to third parties at various times and contingent upon various events according to customer's specifications. Upon contractual agreement the service provider takes on the contractual duty to deliver documents, files and messages anonymously. The administrator also offers the customer the option to publish (e.g. on a website) the documents, the files, the certifications stored on the docket, and other information that customer chooses.

The customer can use the documents and certification to prove priority of inventions, innovations, explanation such as: she is the first inventor of an apparatus, she is the first person that found a scientific explanation for a certain phenomenon; she is the first proponent of a certain economical solution to health-care crisis.

The customer can use the docket system to make various points and prove various state of facts such as: the customer predicted two years in advance that a certain company committed accounting fraud; the customer warned the officials on a certain date that the bridge across the Potomac is likely to collapse; the customer warned her son on a certain date that his business partner Bill is dishonest and likely steals from the business.

The customer can use the docket system to store documents (e.g. email messages, voice messages, text describing certain facts and occurrences) that can be used in legal proceedings or by law enforcement. For instance, Alice (a customer) may upload on the docket a declaration stating that on a certain day her ex-boyfriend threatened to burn down her house. This declaration can be used as evidence in later criminal and/or civil proceedings if the ex-boyfriend ends up burning Alice's house.

The customer can use the docket system to send documents, files and messages anonymously to various parties.

The customer can use the docket system to store valuable documents he or she does not want to be accidentally lost. Examples of such documents are: birth-certificates, social security certificates; property titles; mortgage papers; house purchase contracts; college transcripts; police reports; important emails and letters.

The customer can use the docket system to send messages and make documents available to third parties at various times and contingent upon various events as specified by customer. For instance, the service administrator may take upon the task of delivering to customer's great grand-son on his 21^{st} birthday the following documents: a title to land; a bank account; a literary creation; a letter in which the customer may tell his great-grand-son who is his actual father. The service administrator may take on the duty to complete actions that may take place long after the customer's death (e.g. 50 years).

In the following we describe the invented system and methods in detail.

(1). The offer to provide a service.

The party practicing the invention makes the following contractual offer to various parties: the party practicing the invention promises to take steps to ensure that the information provided by the customers, will be kept in trust for the customer. The party practicing the invention also promises to provide the customer and third parties with the stored documents and information associated with said stored documents, according to customer's request and specifications.

The above promise is performed upon customer providing the party offering the service with the information that the customer wants to be kept in trust and upon the customer performing other promises such as paying a fee.

The offer can be made over the internet, by an on-line service, in newspapers, on television, on the radio, etc. The parties can use various means to enter in a contractual agreement such as: contract signed via an on-line service, paper contract, etc.

(2). Receiving information, documents, and files from customers.

The party practicing the invention receives the information that the customers want to be stored in trust for the customer. The information can be collected in various forms such as: digital form, text written on paper, etc.

A way to collect said information is via an internet/on-line service. The party practicing the invention offers an on-line service where customers open a private account accessible by username and password (similar to an account on Gmail, Facebook, etc.). On said account the customers store information by uploading files, by creating new files, and by editing files. Said files may be of various types (e.g. text, drawings, pictures, movies, sound, and data) and may hold various types of information. Other ways to collect such information from customers can be employed such as: by email (customer sends an email to the administrator with the information to be kept), mail, and in person.

(3). Saving, time stamping, and time tracking the stored information.

For each document a customer has uploaded or created on the docket system, the docket service saves the time said document has been uploaded or created. The docket service may create a time-stamp (similar to the way the United States Patent Office associates time-stamps to submitted patents). This way the customer can prove that she created that specific document before the specific time on the time-stamp. The time-stamped documents can be used by the customer to prove authorship and priority of inventions, ideas, creations, innovations etc.

For the sake of clarity, we present a fictional situation showing how customers would use the invented system. Consider Jane, a scientist who just performed a couple of experiments based on which she found an explanation to a certain phenomenon (e.g. the decrease of the number of honey-bees in North America, the link between exposure to a certain chemical and cancer). Jane would open an account on the invented service (username and password protected) and upload files describing her explanation of said phenomenon. Jane can also upload data files supporting her explanation. The service will assign a time-stamp to each file uploaded by Jane. This way Jane can prove to other people that she is the first who came up with the explanation for the specific phenomenon and, if available, show the data that supports her explanation.

The service provider employs a means to track in time all the changes that a customer made in the account such as: documents created, login sessions, deleted and modified files, and any other activities involving the account.

(4). Customers can view, download, delete, and organize the files stored on the docket.

The docket service provides a feature allowing customers to view, download and delete previously created documents and the information associated with such documents (e.g. time-stamps, signatures, and certification associated with said documents). For instance, the customer can access her account and see a list of the documents created, the corresponding time-stamps and the certification files. The customer can download such documents and files. The customer can organize the documents in folders and view the documents by clicking on them.

(5). Certifying with respect to customer's identity, swearing behind declarations and signing declarations.

The party practicing the invention provides a way for the customers to certify with respect to their identity, swear behind their declarations, and sign such declarations. For instance, the customer may assert that to the best of her knowledge she is the first to give such explanation (i.e. as described in the documents stored on the docket system) to a certain phenomenon, or that she is the first author of a certain musical creation, philosophical idea etc. A sworn declaration that customer's assertions are true adds to the value and weight of such assertions. This feature is optional.

(6). Issuing certificates of validity associated with the documents created on the docket, the time documents were created, and the identity of the person that created the documents.

The party practicing the invention may issue certificates of validity or declarations specifying: that the customer has created a certain document at the time on the time-stamp; that the customer has submitted the affidavit declaration with respect to his identity; and that the customer has submitted other affidavit declarations and documents with respect to the said document (e.g. declaration that to the best of his knowledge he is the first to find the phenomenon described in the document). The administrator of the service is legally bound (like a notary) and contractually bound to be truthful with respect to all assertion in such certification.

The party practicing the invention offers a feature such that the customers can direct the service provider to create said certification and to make it available to the customers and to third parties, according to customer's specifications. The customer would place a request on his account to obtain a certification from administrator with respect to a document. In response, the administrator issues a certificate (in digital or physical form) and makes it available to the customer and to the third parties as requested by the customer.

For example, a certificate issued by the administrator may contain the following declaration: “I, William Doe as the administrator of the docket service, declare under penalty of law that the customer has created document X attached to this certificate at the time specified by the time stamp on this certificate; that the customer has declared his identity to be the one specified in this certificate; and that the customer has submitted the attached affidavit-declaration with respect to said document X on the docket. Signed by William Doe, administrator of the service and public notary”.

(7). Keeping the documents safely, securely and confidentially, and making said documents available to the customer and to third parties according to the agreement between the customer and the service provider.

The party practicing the invention is legally bound (e.g. like a notary) and contractually bound to store the documents on the docket (including the time-stamps, and any other declarations associated to said documents) and make them available upon request by the customers. The legal and contractual duty imposed upon the administrator will require that he employs a certain level of diligence with respect to keeping the documents securely and making them available to customers upon request. For instance, if the party practicing the invention goes bankrupt he has the duty to inform the customers, to provide customers access to their documents, to surrender the documents to other parties willing to take over the service, to deliver the documents to the customers or customer's assignees. The documents on the docket are treated as valuable documents and the administrator has a contractual duty to keep them securely, confidentially, and make them available to the customer or other parties as the contract specifies. The docket acts as an on-line accessible Safety-Deposit-Box. Various levels of security and protection of information can be implemented (e.g. copies of the documents can be stored on “write only” memory storage such that hackers cannot delete or modify them).

On a contractual basis (between customer and administrator) the administrator will hold documents on the docket for certain period of time as specified by the contract (even after the customer has died) and make the documents available to other parties. For instance, such a contract may specify that the administrator will deliver a certain document and message to the oldest of customer's descendants who is alive in year 2075. On a contractual basis the administrator employs certain levels of effort (commensurate with the fee paid) to find the right person/destination. For instance, the administrator duty may be to send a message to an email address, or to send a letter to a physical address, or the administrator may take on the contractual duty to employ higher levels of effort in finding the right destination/person (e.g. contact Social Security Administration, check the phone book, check with other relatives).

(8). Providing customers with various forms of certification and ways of proving that their assertions with respect to the documents stored on the docket system are true.

The administrator can issue certification in many forms. A feature can be implemented whereas a time-stamp and certification-stamp is placed over the documents (e.g. by superimposing a small image stamp over the text or image files). A feature can be implemented whereas a certification form is attached to the original document stored on the docket (e.g. another page is attached at the end of the text or image file created by customer).

A feature is implemented whereas a special file format is created where a file in this said special file format is composed of more individual files. In this case, the composed file will comprise the original document file, the time stamp-file, and other the associated certification files. A feature is implemented whereas a “special file format” is created specifically for storing certified documents where the files stored in this “special file format” cannot be modified and it is illegal to modify or use modified files for any reason (in the same way it is illegal to modify and use modified checks and modified bank notes). A provision may be added at the end of such files specifying that it is illegal to modify such fields and to use modified files.

Also customers can prove they authored a certain document by printing the document from the docket website or by providing interested parties with a link to a website screen that shows the documents and the associated certifications.

(9). Customers can make available the documents on the docket and the associated certificates to various third parties such as: individuals, groups, employers, organizations, associations, universities, or the general public.

The customer has the option to send the documents on the docket and the associated certification to various parties by email, email attachment, by providing a website-link to the documents or any other means.

Upon request by the customer, the administrator will deliver specific documents and associated certification on the docket (as specified by the customer) directly to third parties (the docket administrator is the sender whereas the third party is the receiver). This process is similar to the way individuals ask the schools they graduated from to send their student transcript to universities, employers, scientific organizations etc.

Upon request by the customer, the administrator will provide the specific documents and associated certification requested in a sealed envelope with the specification that when presented to third parties the certification is valid only if the envelope is sealed. This feature is similar to the way universities give students transcripts in a sealed envelope with the specification that the transcript is “void” if the envelope is presented to a third party unsealed.

(10). The service provider maintains a website where customers can publish the documents stored on the docket and their associated certification.

Customers are provided with the option of publishing on a website (referred herein after as “publication website”) desired documents on the docket. The published documents may express ideas, opinions, innovations, declarations etc. The customer can also publish on the website text describing and referring to documents on the docket. Other means to make the information available to the public at large can be employed.

The information published on the publication website is organized on categories and sub-categories based on subject matter, date of creation, author, institutions etc. Examples of such subject matter categories are: software, intellectual property law, optics, analytical chemistry, molecular-biology, nano-technology, green energy etc. A feature will be implemented whereas the customer can assign each published document within one or more categories. The administrator of the publication website will provide supervision and impose various rules to ensure that documents are published under the right category. The administrator of the website may implement a feature that the viewers can comment with respect to the published documents.

(11). A means to set accessibility features.

The docket system implements a feature whereas customers have the option to allow various parties (e.g. co-inventors, the lawyer, co-workers, and relatives) access to view and modify certain documents on the docket. This feature allows more people to work on a certain project for which the documents associated with said project are stored on the docket.

(12). Implementation of contingent actions.

The invented docket system offers the customer the option to set various contingent actions (e.g. send emails, deliver messages, deliver documents) which may happen upon the happening of one or more events (i.e. triggering events). For instance, the customer can set the system to do the following: if customer does not access the docket for a certain period of time (e.g. there is no log-in for a 100 days period) the docket will automatically send an email to various parties pre-specified by the account owner (e.g. family, friends, docket administrator, police, and lawyer). This feature is especially useful in the event the account owner dies because it ensures that the information on the docket (e.g. an invention, a scientific discovery, important documents) is made available to other parties. In the absence of such a feature the information a person stores on the docket would be lost once the person dies.

This feature is useful in other circumstances. For instance, an inventor that has an account on this system can set the system to send her an email every two weeks in order to remind her that she needs to exercise diligence in prosecuting an invention patent.

Various types of “events” can be implemented as “triggering events.” Various types of actions can be performed upon the happening of a triggering event. For instance, the account owner can set a contingent action such that an email will be sent to a newspaper and police on a certain date or upon a change in the legal system, or upon the bankruptcy of a company. The account owner can set the system to deliver a certain document to various people at various times (e.g. 10 days later, 2 years later, 50 years later). Each of such contingent action is performed upon contractual agreement between the customer and administrator. The delivery of a message 50 years later is definitely more expensive than the delivery of a message in a couple of days. The administrator is contractually bound to execute his part of the bargain.

The service provides customers with the option of choosing various actions that the docket administrator should take (with respect to the documents customers store on the docket) upon the happening of a certain triggering event. Upon request by the customer and according to customer's specifications, the administrator will deliver (e.g. by email, by mail) to various parties the specific documents stored on the docket.

This feature can be implemented in an automatic way such that no human intervention is necessary. Various levels of effort and expense can be implemented to find the parties to whom the documents should be delivered and to deliver said documents.

(13). Testifying with respect to documents stored on the docket.

Upon request by the customer, the administrator acts as a witness for customer in judicial or other proceedings, whereas the administrator testifies that the customer has uploaded and created the specific files at the times shown by the time-stamps. This service is provided upon request by customer and upon satisfying other conditions such as paying a fee.

Various levels of security, sophistication, and levels of proof will be implemented for each of the above features upon request by the customer and on a contractual basis.

(14). Method for facilitating the proving of authorship and priority of ideas, discoveries, creations, inventions, and innovations.

The invented method provides a solution to the problem described in subsection 1 of section D. The method is described in the following. An independent legally bound party provides a service consisting essentially of a docket system as the one described in subsections 1-13 of section E. Customers (e.g. creators, innovators, inventors, scientists) store on said docket system one or more documents describing their ideas, discoveries, creations, explanations, or innovations. Customers perform the storing of the said documents on the docket soon after (as soon as possible) the time they discovered or came up with said ideas, creations, inventions, innovations or explanations. The docket system stores said documents and the associated time-stamps showing when the documents have been created. The customer (or other parties) can use the documents stored on the docket, and the corresponding time-stamps, to prove that said documents have been created by certain persons at or before a certain date and time. The customer can use said documents in legal proceedings, disputes, to make a point, or for any other purpose etc. Upon request by said party, said docket service testifies with respect to said files and documents that said files have been stored on said docket at certain date and time. The customer can set the contingent action features offered by the docket service such that messages and documents are delivered to third parties (e.g. customer's family, lawyer, descendants) when certain triggering events happen. The triggering event can be the elapse of a certain period of time (e.g. at 150 days) after said customer did not access his account, or the 21^{st} birthday of a certain party, or a certain date etc. The service provider offers said customers the option to publish documents they want (with respect to their ideas, creations, innovations, inventions) on a website.

For the sake of clarity, we explain how the system works by considering the concrete problem presented in subsection 1 of section D with respect to John Smith (the post-doctoral junior scientist). John, having knowledge of a service implementing the docket system, would go right after he came up with his idea on the docket website and open an account (e.g. similar to opening of an account on Monster.com or Google). On that account he would upload documents (written descriptions, drawings, pictures, movies etc.) that provide a basic description of his ideas. This way the scientist secures evidence that proves he authored that idea (with respect to a discovery, an explanation, an invention, or a creation) before the time he uploaded the document on the docket. Such evidence can also prove that he is the first person that came up with that invention, creation, or explanation. After said scientist secures evidence that he authored that idea, he can talk with his colleagues without being afraid that someone will misappropriate said idea. The scientist does not need to tell anyone that he stored a document describing his idea on the docket system. The scientist can bring the evidence in the docket to support his claims of authorship and priority if disputes with respect to that arise. When more than one person has contributed to a certain discovery or creation, a person can bring the documents on the docket to show what his contribution to the specific discovery or creation was.

The scientist will set the contingent action feature of the docket system to perform the following: if scientist' account is not accessed for 100 days the system will send an email to the parties designated by scientist (e.g. his family, his lawyer) and deliver them the documents in the docket; second, every two weeks the system will send an email to the customer reminding him to work on the patent application. These contingent action ensure the following: if the customer dies his ideas, discoveries, creations and inventions are not lost and these discoveries, ideas, creations and inventions are send to the parties that the customer choses.

(15). Method of facilitating the securing of evidence in support of claims of authorship, conception, and diligence with respect to inventions.

The invented method provides a solution to the problem described in subsection 2 of section D. The method is described in the following. An independent legally bound party provides a service consisting essentially of a docket system as the one described in subsections 1-13 of section E. Customers (e.g. prospective inventors) store on said docket system one or more documents describing their inventions or perfecting inventions. Customers perform the storing of the said documents on the docket soon after (as soon as possible) the time they conceived said inventions. Customers perform the storing of the said documents on the docket soon after (as soon as possible) they came up with improvements of certain inventions. In order to prove they are diligent, customers store documents describing their work towards bringing inventions to reductions to practice. This action is performed periodically and every time work is performed towards the reduction to practice. The docket system stores said documents and the associated time-stamps showing when the documents have been created. The customer (or other parties) can use the documents stored on the docket, and the corresponding time-stamps, to prove that said documents have been created by certain persons at or before a certain date and time. The customer (or other parties) uses the documents stored on the docket and the corresponding time-stamps to prove that said inventor has conceived the invention corresponding to a certain claim at a certain time, that diligence has been exercised in bringing the invention from conception to reduction to practice, and that the customer is a co-author of certain claims of an invention authored by multiple parties. The customer can use said documents in legal proceedings, disputes, to make a point, or for any other purpose. Upon request by said party, said docket service testifies with respect to said files and documents that said files have been stored on said docket at certain date and time. The customer can set the contingent action features offered by the docket service such that messages and documents are delivered to third parties (e.g. customer's family, lawyer, descendants) when certain triggering events happen. The triggering event can be the elapse of a certain period of time (e.g. at 150 days) after said customer did not access his account, or the 21^{st} birthday of a certain party, or a certain date etc. The service provider offers said customers the option to publish documents they want (with respect to their ideas, creations, innovations, inventions) on a website.

A person facing the problem described in subsection 2 of section D will use the method in a manner similar to the one described in subsection 14 of section E above. By uploading documents on the docket system, an inventor can prove conception, diligence and contribution with respect to each individual claim.

(16). Method for facilitating the secure storing of documents.

The invented method provides a solution to the problem described in subsection 3 of section D. The method is described in the following. An independent legally bound party provides a service consisting essentially of a docket system as the one described in subsections 1-13 of section E. Customers store on the docket system documents that said party wants kept securely and confidentially. The docket system stores said documents securely and confidentially. The docket service makes the documents available to customer and third parties upon request by customers. The customer can set the contingent action features offered by the docket service such that messages and documents are delivered to third parties (e.g. customer's family, lawyer, descendants) when certain triggering events happen. The triggering event can be the elapse of a certain period of time (e.g. at 150 days) after said customer did not access his account, or the 21^{st} birthday of a certain party, or a certain date etc.

A person facing the problem described in paragraph 3 of section II will use the method in a manner similar to the one described in subsection 1 of section E above except for the fact that the documents are not stored for the purpose of proving authorship or priority of ideas but the documents are of the type that customer wants not to get lost (e.g. title certificates, birth certificates, contracts, letters, educational transcripts etc.). By storing documents on the docket system, a party ensures that the documents are securely kept and, in the event the customer dies or becomes incapacitated, said documents are sent to the parties that customer choses.

(17). Method of facilitating the securing of evidence for use in law enforcement and in legal proceedings.

The invented method provides a solution to the problem described in subsection 4 of section D. The method is described in the following. An independent legally bound party provides a service consisting essentially of a docket system as the one described in subsections 1-13 of section E. The customer stores on the docket system documents describing acts indicative of criminal activity and acts that may be relevant in current or future legal disputes. Said party may also store files that may be relevant to legal disputes such as: emails, voice-messages, pictures, videos etc. Said storing is performed soon after the customer has witnessed the acts. The docket service stores said files and documents confidentially and securely. The docket service makes said files available to the customer or other parties upon request by the customer. The customer uses the stored documents in legal proceedings, provides them to law enforcement, disputes or for any other purpose etc. Upon request by said party, said docket service testifies with respect to said files and documents that said files have been stored on said docket at certain date and time. The customer can set the contingent action features offered by the docket service such that messages and documents are delivered to third parties (e.g. customer's family, lawyer, police, newspapers) when certain triggering events happen. The triggering event can be the elapse of a certain period of time (e.g. at 150 days) after said customer did not access his account, or a certain date etc.

By using the above method a person facing the problem described in subsection 4 of section D secures more reliable evidence than if she does not use the method. For the sake of clarity, we explain how the system works by considering a fictional situation encountered by a fictional person we call Jane. Jane receives threatening emails, voice-mails and phone calls from her ex-boyfriend. Two months later, at midnight, she sees in the dark behind her house a person carrying a canister. The person, who looked like her ex-boyfriend, runs away when he sees Jane.

First we consider what would happen if Jane does not use the invented method. Jane saves the emails from her ex-boyfriend on her Yahoo account. Four months later she misplaces the emails and accidentally deletes them. The voicemail on her phone is lost after two months. She did not tell anybody about the threats because she is embarrassed. Fourteen months later the ex-boyfriend sets fire to her house. Jane goes to police and tells them about the boyfriend but can provide them neither the emails nor the voicemails. She tells police that she saw the boyfriend at night in the vicinity of her house but she does not remember the date or details of what the boyfriend carried since it happened more than one year ago. Police concludes they have too little to start an investigation against the boyfriend.

Now we consider what would happen if Jane used the docket system described in this invention. Once Jane received the threatening emails and voicemails she would have opened an account on a docket system where she would have stored the threatening emails and voice-messages. Right after witnessing the ex-boyfriend sneaking around her house at midnight, Jane would have written a detailed description of the facts witnessed (i.e. that she saw her ex-boyfriend carrying something that looked like a canister; that the ex-boyfriend ran away when he saw Jane) and the date and time those facts happened. Fourteen months later the ex-boyfriend sets fire to her house. Jane goes to police and provides them with the emails and voice-messages stored on the docket and with the detailed description of the facts witnessed by Jane. The documents on the docket are reliable as evidence because they have been produced at the time the events happened and because the time-stamp on the documents shows the date the documents have been uploaded. Also, the service administrator can testify that the documents have been created at the claimed date. Accordingly, police concludes they have enough evidence to start an investigation against the ex-boyfriend.

(18). Method for deterring the killing and the kidnapping of people.

The invented method provides a solution to the problem described in subsection 5 of section D. The method is described in the following. An independent legally bound party provides a service consisting essentially of a docket system as the one described in subsections 1-13 of section E. The customer stores on the docket system documents describing, criminal acts, acts indicative of criminal activity and acts that may be relevant in current or future legal disputes. Said customer also stores files that may be relevant to legal disputes such as emails, voice-messages, pictures, videos etc. The docket service stores said files and documents confidentially and securely. The customer sets the contingent action feature offered by said docket service such that a message and certain documents are delivered to a third party (e.g. police, newspaper, customer's family) when a certain triggering event happens. Said triggering event can be the elapse of a certain period of time (e.g. at 150 days) after said customer did not access his account. The docket service makes said files available to said third parties upon the happening of the triggering event or upon request by the customer. The third parties use said documents delivered to them in law enforcement, in legal proceedings, newspaper articles etc.

In the following we explain how the system works by considering a fictional situation encountered by a fictional person we call John. John is an accountant for Bob who is a businessman involved in criminal activity. John knows of Bob's criminal activity but John cannot go to police because he helped Bob with the fraudulent accounting. John feels that Bob wants him killed because John knows too much. John opens a confidential and secure account on the internet based docket system where he stores a document describing Bob's crimes. John sets the following contingent action on his account: if the account is not accessed for 120 days then an email with the document describing Bob's crimes will be automatically sent to police, John's family, his lawyer and newspapers. This way Bob is deterred to kill John because if he kills John police will automatically find out about Bob's crimes.

This method offers to persons that have knowledge of crimes a way to disclose the information they have about crimes after said persons have died and without suffering the consequences of disclosing such crimes (e.g. retaliation from criminals, prosecution from participating to the disclosed crimes). The method also offers people a way to confess about their crimes after they have died and without suffering the consequences of confessing. The most important benefit to the users of this method is that once the criminals know about the system they realize that by killing people it is more likely to have information released to authorities than by not killing them. Consequently, employing such a method deters the killing and kidnapping of persons who have knowledge about criminal activities.

(19). Method for facilitating the delivering of documents and messages to the desired persons at the desired time.

The invented method provides a solution to the problem described in subsection 6 of section D. The method is described in the following. An independent legally bound party provides a service consisting essentially of a docket system as the one described in subsections 1-13 of section E. The customer stores on the docket system documents he wants delivered to third parties in the future or upon happening of a certain event. The docket service stores said files and documents confidentially and securely. The customer sets the contingent action feature offered by the docket service such that a message and documents are delivered to third parties (e.g. customer's family, lawyer, descendants) when a certain triggering event happens. Said triggering event can be the elapse of a certain period of time (e.g. at 150 days) after said customer did not access his account, or the 21^{st} birthday of a certain party, or a certain date etc. The docket service makes said files available to said third parties.

For the sake of clarity, we explain how the system works by considering a concrete situation encountered by a fictional person we call Mary. Mary has a severe heart disease and is afraid she will die any day. Mary is a single mother of a 5 years old son, William. Mary knows that there are a couple of very important facts that William needs to know but he is too young right now. Mary would like William to be informed on his 21^{st} birthday about the following: first that William's actual father is not John, as William knows, but Andrew; second, that William is predisposed to a certain genetic disease which runs in Mary's family; and third Mary wants William to receive the shareholder certificates of a business she inherited from her father. Mary will ensure William receives this information on his 21^{st} birthday by using the internet docket as follows: Mary opens an account on the secure and confidential docket where she uploads a document describing the above facts and a copy of the shareholder certificate. Mary sets her account to send an email with the documents attached to William on his 21^{st} birthday. Mary also can pay an extra-charge to the account such that the administrator acts as her trustee and administrator takes extra measures to ensure that William receives the message. This system is in effect a cheap trustee.

(20). Method for facilitating the proving that one or more person made certain affirmations, declarations, statements, assertions, predictions, or expressed certain beliefs.

The method is described in the following. An independent legally bound party provides a service consisting essentially of a docket system as the one described in subsections 1-13 of section E. The customer stores on said docket system documents describing assertions, opinions, predictions, declarations, and factual statements made by one or more parties with respect to various issues such as education, healthcare, public policy, weather, environment, sports, politics, movies etc. The docket system stores said documents and the associated time-stamps when said documents have been created. The customer uses the documents stored on the docket and the corresponding time-stamps to prove that the customer has created said documents before a certain date. The customer uses said documents to prove that customer (or other parties) has made said assertions, opinions, predictions, declarations, and factual statements at the times shown by the time-stamps. Upon request by the customer, the docket service testifies with respect to said files and documents that said files have been stored on said docket at certain date and time. The docket service makes said files available to the customer or other parties upon request by the customer. The service provider offers said customers the option to publish documents they want (with respect to their assertions, statements, declarations) on a website.

Customers use the docket documents to prove that they issued an opinion, made an assertion, or made declarations with respect to various issues at a certain moment in time. This way they can later make a point they held those opinion and made those assertions at the specific moment.

For the sake of clarity, we explain how the method works by considering a concrete situation encountered by a fictional person we call Mary. On a certain date Mary stores on the docket a document declaring that she believes that a certain company committed accounting fraud; or that she warned the officials on a certain date that the bridge across the Potomac is likely to collapse; or that she warned her son on a certain date that his business partner is dishonest and cheats on accounting. Two years later, when her predictions turn out to be right, she can show various people that she was right about those issues, tell them “I told you so”, and show that she exercised diligence. Mary can also store on the docket document in which she makes factual statements such as: today I saw in the restaurant parking lot a person handing a thick pack of $100 bills to the police chief, I think it was a bribe.

Statements can come in the form of agreements and wagers such as: we, Bill, John, Sarah and Alice agree that whoever among us gets the highest score at the Biology exam cooks dinner for the others.

We specify with respect to the invented methods that since most of the actions performed by the service provider can be performed automatically by systems of computers (without the need of human intervention) it is expected that the implementation of these methods will be relatively inexpensive both for service providers and for customers.

### BEST MODE AND PREFERRED EMBODIMENT

(1). Opening an account on the internet based docket service.

The party practicing the invention maintains a website where the potential customer is prompted to open a secure and confidential account by choosing a username and password. The website administrator allows the customer to open an account on the website upon completion of the contractual agreement. The customer is informed of the contract terms, agrees with said terms and pays a fee. The process is similar to opening an account on a service such as Gmail.

(2). Uploading the documents to be kept and creating documents.

When the customer wants to upload documents on the account she accesses the account by entering her username and password. The service provides the customer with website controls (e.g. select and upload buttons) such that the customer can select and upload the desired documents. The service also provides a way for the customer to create her own documents via a text-editor and save said documents as text.

(3). The docket keeps each document with its associated time-stamp.

The service provider automatically attaches to each document the time that the said document has been uploaded or created via text editor or other types of editors. The service creates a time-stamp associated with each document on the docket. Neither the customer nor anyone else can change the time-stamp of a document. The service provider is legally and contractually bound to keep each document on the account with its corresponding time-stamp.

(4). The docket account website offers the customer a way to certify with respect to her identity, to swear behind assertions in the documents and to sign declarations.

The docket offers the customer an on-line fill-in form where the customer gives a declaration with respect to her identity (e.g. “under penalty of law I declare that my name is Jane Doe”) and gives her address and other identifying information. This is an optional feature.

The docket system provides on-line fill-in forms by which the customer swears that the assertions in a certain document are true to the best of her knowledge. For instance, the customer may assert in one of the documents that she is the first to give a certain explanation to a certain phenomenon, or that she is the first author of a certain literary creation, philosophical idea etc. The system docket will employ a means to sign on-line documents similar to the one used by USPTO.

(5). The customer can view, download, delete, and modify documents on the docket.

The docket website interface provides a way for the customer to see each document on the account and the corresponding time when said document has been created. The customer can download and delete documents on the docket. A customer can also modify documents but the system keeps track of all modifications and associates new time-stamps to the modified documents. When customer modifies an existing document the docket keeps a copy of the original (before modification) document with its associated time-stamp and creates a new document (the modified document) and associates a new time-stamp with the time the new modified document has been created.

For instance, the customer accesses her account and sees a list with all the documents created and the corresponding time-stamps and certification files. The customer can download said documents. The customer can organize said documents in folders.

(6). Upon request by the customer, the administrator of the docket issues certificates associated with the stored documents, the time documents have been created and the identity of the person that created the documents.

The account website interface offers a way for the customer to place a request to obtain certification from administrator with respect to a certain document. The customer chooses the file from the list by checking a check-box associated with that file and pushes a button “request certification”. In response, the administrator digitally makes a certificate with the seal, stamp, and signature of the administrator in the form of a PDF file. The issued certificate associated with a certain document on the docket certifies: that the customer has created the specific document at the time on the time-stamp; that said customer has submitted the affidavit declaration with respect to his identity; and that said customer has submitted other affidavit declarations and documents with respect to said document (e.g. declaration that to the best of customer's knowledge he is the first to find the phenomenon described in the document). The administrator is legally bound (like a notary) and contractually bound to be truthful with respect to all assertions in such certification. The administrator employs an automated way to create such certificates.

Such certificates issued by administrator will contain a declaration like the following: “I, William Dean as the administrator of the docket service, declare under penalty of law that the customer has created the document attached to this certificate at the time specified by the time-stamp on this certificate; that the customer has declared his identity to be the one specified in this certificate; and that the customer has submitted the attached affidavit-declaration with respect to said document. Signed by William Dean, administrator and public notary.”

The administrator uploads this PDF certificate file on customer's account. The customer can download, print, email this file as attachment to whoever he wants and post this file on websites as evidence in support of his claims and assertions.

The administrator of the service is legally and contractually bound to keep the documents on the docket, the time-stamps, and any other declarations with respect to the documents and make them available to the customers upon request. The legal and contractual duty imposed upon the administrator requires that the administrator employs diligence with respect to keeping the documents securely and making them available to customers upon request. The administrator has the duty to keep aside financial resources such that in the eventuality he goes bankrupt he has the resources to provide access for the customers to retrieve all the documents on the docket together with the certification and time-stamps. Various levels of security and protection of information are implemented (commensurate with customer's request and payment of associated fees). Copies of documents are stored on “read-only” memory storage such that internet-hackers cannot delete or modify them.

The administrator will provide customer, upon request, with certification in various forms such as: the administrator will digitally create a printable certificate (e.g. like a diploma) attached to the underlying document; the administrator will digitally place a time-stamp and certification-stamp on the created-documents on the docket; the administrator will attach a certification form to the originally created file.

(7). The administrator maintains a publication website where customers can publish the documents holding ideas, opinions, innovations, and declarations.

The customers have the option to post on said website various documents (e.g. documents stored on the docket). The default status of the documents stored on the docket is that they are confidential (they are not posted on the publication website) and only the account owner can access them. The customer has the option to post a document on the publication website by using a “publish” button and choosing the file to be published from his docket account. The customer can also publish on the publication-website text describing and referring to documents on the docket.

The information published on the website is organized on categories and sub-categories based on subject matter, date of creation, author, institution etc. Examples of such subject matter categories are: optics, analytical chemistry, molecular biology, nanotechnology, particle physics, business ideas etc. The customer will assign each document she wants published in one or more categories. The administrator of the website will provide supervision and impose various rules to ensure that the various published documents are published under the right category.

(8). The docket provides the customer with means to set contingent actions.

The evidence holding docket offers customers the option to set contingent actions (such as send email notifications to various parties) which are performed upon the happening of one or more events (called “triggering events”).

For instance, the customer can set the following contingent actions: if customer's account is not accessed for a certain period of time (e.g. for 100 days) the docket will automatically send an email to the addresses pre-specified by the account owner. This feature is especially useful in the event the account owner dies or becomes incapacitated because it makes the information stored on the docket (e.g. an invention, a scientific discovery, an artistic creation) available to other parties. In the absence of such feature said information would be lost.

The service offers customers the option to implement various types of “triggering events”. Examples of such triggering events are: the customer does not access the account for a preset number of days; a certain date and time is reached; the docket receives a notification email that a certain stock price fell below a threshold. The docket offers the customer the option to implement logical combinations of such triggering events such as: the email will be sent upon the happening of both event-1 and event-2. Notification emails can be sent to various parties such as: private parties, newspapers, police etc.

(9). Option to send anonymous emails and letters.

The service provider offers customers a way to send emails and messages anonymously. For instance, the account owner may want to send to police a document on the docket (e.g. document revealing accounting fraud) and remain anonymous.

(10). Upon request by customer, the administrator will act as witness and certify on behalf of the customer.

Upon request by the customer, the service provider testifies that the customer has created specific files at the times indicated by the time-stamp. The administrator may testify for the customer in judicial proceedings and or in any other circumstances.

Although the present invention has been described with respect to the preferred embodiment, numerous modifications and variations can be made and still the result will come within the scope of the invention. No limitation with respect to the specific embodiment disclosed herein is intended or should be inferred.

What is claimed is:

1. A method for securing evidence supporting one or more persons' claims that said persons authored one or more ideas, or discoveries, or explanations, or creations, or innovations, or inventions, or assertions, or statements, the method comprising:
(a) offering said persons a computer and internet based system wherein said persons open a confidential account and wherein said persons upload or create documents supporting claims of authorship or documents describing one or more of the following: said ideas, said discoveries, said explanations, said creations, said innovations, said inventions, said assertions, and said statements;
(b) keeping said documents confidentially and securely, wherein said documents are accessible only by said persons or with permission from said persons;
(c) keeping time stamps associated with said documents indicating dates and times when said documents have been uploaded or created;
(d) making said documents available to said persons or to third parties according to instructions given by said persons.

2. The method of claim 1, wherein said evidence is used in support of said persons' claims that said persons are the first authors of said ideas, said discoveries, said explanations, said creations, said innovations, said inventions, said assertions, or said statements.

3. The method of claim 1, wherein said evidence is used in support of said persons' claims that said persons exercised diligence in bringing said inventions from conception to reduction to practice.

4. The method of claim 1, further comprising a website where said persons have the option to publish said documents stored on said system.

5. The method of claim 1, further comprising:
(a) testifying or certifying, upon request by said persons or their agents that said documents have been received or created at said dates and said times.

6. A method of providing a service to persons, wherein by using said service said persons secure evidence which can be used in law enforcement and in legal proceedings, the method comprising:
(a) offering said persons a computer and internet based system, wherein said persons open an account and upload or create documents such as documents describing criminal acts, documents describing tortious acts, documents describing acts indicative of criminal activity, documents describing acts that may be relevant in legal disputes, and documents and files relevant to legal disputes and law enforcement;
(b) keeping said documents confidentially and securely, wherein said documents are accessible only by said persons or with permission from said persons;
(c) keeping time stamps associated with said documents indicating dates and times when said documents have been uploaded or created;
(d) making said documents available to said persons or to third parties according to instructions given by said persons.

7. A method of providing a service to persons who have knowledge of criminal acts and are afraid they may be killed by one or more parties because of their knowledge of said criminal acts, wherein by using said service said persons deter said parties from killing said persons, the method comprising:
(a) offering said persons a computer and internet based system, wherein said persons open an account and upload or create documents such as documents describing criminal acts, documents describing tortious acts, documents describing acts indicative of criminal activity, documents describing acts that may be relevant in legal disputes, and documents and files relevant to legal disputes and law enforcement;
(b) keeping said documents confidentially and securely, wherein said documents are accessible only by said persons or with permission from said persons;
(c) making said documents available to said persons or to third parties according to instructions given by said persons.

8. The method of claim 6, further comprising:
(a) testifying or certifying, upon request by said persons or their agents that said documents have been received or created at said dates and times.

9. A method of providing a service to persons, wherein by using said service said persons keep important documents safely and securely, the method comprising:
(a) offering said persons a computer and internet based system, wherein said persons open an account and upload digital copies of documents they want kept securely and confidentially;
(b) keeping said documents confidentially and securely, wherein said documents are accessible only by said persons or with permission from said persons;
(c) keeping time stamps associated with said documents indicating dates and times when said documents have been uploaded or created;
(d) making said documents available to said persons or to third parties according to instructions given by said persons.

10. The method of claim 1, wherein said system comprises a feature facilitating that said persons program said system to perform actions, such as sending documents and messages to third parties, upon the happening of one or more events, such as the elapse of a preset period of time in which the account has not been accessed, or the reaching of a certain date and time.

11. The method of claim 6, wherein said system comprises a feature facilitating that said persons program said system to perform actions, such as sending documents and messages to third parties, upon the happening of one or more events, such as the elapse of a preset period of time in which the account has not been accessed, or the reaching of a certain date and time.

12. The method of claim 7, wherein said system comprises a feature facilitating that said persons program said system to perform actions, such as sending documents and messages to third parties, upon the happening of one or more events, such as the elapse of a preset period of time in which the account has not been accessed, or the reaching of a certain date and time.

13. The method of claim 9, wherein said system comprises a feature facilitating that said persons program said system to perform actions, such as sending documents and messages to third parties, upon the happening of one or more events, such as the elapse of a preset period of time in which the account has not been accessed, or the reaching of a certain date and time.
